(19) United States
(12) Patent Application Publication
(10) Pub. No.: US 2024/0117125 A1
(43) Pub. Date: Apr. 11, 2024

(54) REGENERATED POLYMER ALLOY MATERIAL AND METHOD FOR PREPARING SAME

(71) Applicant: CHINA NATIONAL ELECTRIC APPARATUS RESEARCH INSTITUTE CO., LTD., Guangdong (CN)

(72) Inventors: Nuo CAO, Guangdong (CN); Jiaqi HU, Guangdong (CN); Yonggao FU, Guangdong (CN); Ling WANG, Guangdong (CN); Chao WAN, Guangdong (CN)

(73) Assignee: CHINA NATIONAL ELECTRIC APPARATUS RESEARCH INSTITUTE CO., LTD., Guangdong (CN)

(21) Appl. No.: 18/273,268

(22) PCT Filed: Nov. 22, 2022
(86) PCT No.: PCT/CN2022/133451

§ 371 Date: Jul. 19, 2023

(30) Foreign Application Priority Data
Nov. 26, 2021 (CN) 202111423874.4

(51) Int. Cl. C08G 81/02; C08L 87/00

(52) U.S. Cl. CPC C08G 81/021; C08L 87/005; C08L 2207/20

(57) ABSTRACT

A regenerated polymer alloy material is provided. The regenerated polymer alloy material is mainly prepared from the following raw materials in parts by mass: a waste HIPS: 55-70, a PP: 30-45, an alkylation reaction catalyst: 0.1-0.4, a co-catalyst: 0.1-0.3, and a HIPS-based macromolecular chain extender: 2-8. The regenerated polymer alloy material uses the waste HIPS and the PP new materials as raw materials, to obtain a waste HIPS based regenerated polymer alloy material with excellent comprehensive properties by using two types of chemical modifiers in combination in segments. The waste HIPS based regenerated polymer alloy material has environmental protection and high value. Further, a method for preparing the regenerated polymer alloy material is also provided.

### TECHNICAL FIELD

The present invention belongs to the technical field of material regeneration, and specifically relates to a waste HIPS based regenerated polymer alloy material and a method for preparing same.

### DESCRIPTION OF RELATED ART

High impact polystyrene (HIPS) is a type of polystyrene material with enhanced toughness. The main advantages of HIPS include high impact strength, good gloss, good heat resistance and good flowability, etc. Therefore, HIPS is widely applied in various industries including packaging, electronics, automobiles, and daily necessities. However, the degradation of HIPS may occur during processing and service due to aging, leading to the molecular chain scission and the production of active groups such as hydroxyl and carboxyl groups, accompanied by changes in microscopic phase structure, resulting in a comprehensive decrease in the property of waste HIPS compared with the new material.

Polypropylene (PP) is a widely used general-purpose plastic with good toughness, good solvent resistance, and further advantages including high yield, low price, good molding process and good inclusiveness, so it occupies a very important position in polymer materials.

The alloying of polymer materials can combine the superior properties of matrix materials to achieve high value applications, so that it is also an important research and application direction. It has cost advantage to prepare high molecular alloy from waste materials, but it is necessary to repair the properties of waste materials effectively and improve the compatibility between various matrices to prepare regenerated alloy materials with balanced properties and market demand.

Based on the above situation, if the fundamental repair of waste HIPS will be carried out, comprehensively improving the comprehensive properties of waste HIPS substrate, by fully utilizing the active groups including hydroxyl and carboxyl groups generated after aging of waste HIPS, as well as molecular chain extension and similar compatibility effects, preparing polymer alloys from waste HIPS and PP will obtain a regenerated alloy material with excellent comprehensive properties with in-situ compatibilizers generated effectively improving the compatibility between waste HIPS and PP phases. Due to the large use of waste materials, this material has the advantages of cost-effective and environmentally-friendly properties, and thus has broad application prospects.

### SUMMARY

An object of the present invention is to provide a regenerated polymer alloy material. It uses waste HIPS and PP new materials as raw materials, and two types of chemical modifiers in a segmented combination, to obtain a waste HIPS based regenerated alloy material with excellent comprehensive properties. The regenerated polymer alloy material has dual advantages of environmental protection and high value.

It is also an object of the present invention to provide a method for preparing the regenerated polymer alloy material as described above.

The above-mentioned first object of the present invention is achieved by the following technical solution. A regenerated polymer alloy material is mainly prepared from the following raw materials in parts by mass:
a waste HIPS: 55-70,
a PP: 30-45,
an alkylation reaction catalyst: 0.1-0.4,
a co-catalyst: 0.1-0.3, and
a HIPS-based macromolecular chain extender: 2-8.

The regenerated polymer alloy material in the present invention mainly includes two incompatible matrix phases of waste HIPS and PP. Firstly, the in-situ compatibilizer HIPS-g-PP was generated through Friedel Crafts alkylation reaction under the catalysis of co-catalysts and alkylation reaction catalysts, which improved the compatibility between the waste HIPS phase and PP phase. Then, through the chain extension repair effect of the macromolecular chain extender of the same matrix of HIPS introduced in the later stage, the fundamental improvement is made on the severely deteriorated properties of the waste HIPS phase after aging. Based on the dual effects of in-situ compatibilization of reactive extrusion and chain extension modification mentioned above, the properties of regenerated polymer alloy material has been comprehensively improved, and ultimately, HIPS/PP regenerated polymer alloy material with excellent comprehensive properties have been prepared. It fully demonstrate its high value properties while fully utilizing waste resources.

Preferably, the waste HIPS is a flake material obtained by crushing and homogenizing waste HIPS (waste high impact polystyrene).

Preferably, the PP is a new PP (polypropylene) material.

Preferably, the alkylation reaction catalyst is anhydrous aluminum chloride.

Preferably, the co-catalyst is styrene. The co-catalyst can promote the occurrence of alkylation reactions when combined with alkylation catalysts.

Preferably, the HIPS-based macromolecular chain extender is a high impact polystyrene grafted glycidyl methacrylate (HIPS-g-GMA).

The above-mentioned second object of the present invention is achieved by the following technical solution. A method for preparing the regenerated polymer alloy material, comprising the steps of: mixing the waste HIPS, the PP, the alkylation reaction catalyst and the co-catalyst according to the proportion of the raw materials to obtain a mixture material, adding the mixture material from a main feeding device of a twin-screw extruder to melt the mixture material, controlling a screw rotation speed of the twin-screw extruder to 40-80 rpm, adding the HIPS-based macromolecular chain extender from the fifth processing zone of the twin-screw extruder according to the proportion of the raw materials to blend with a melted mixture material, and then extruding, drawing, cooling and pelletizing to obtain the waste HIPS based regenerated polymer alloy material.

In the method for preparing the regenerated polymer alloy material:
preferably, the range of the processing temperature of the twin screw extruder is 175-235° C.,
preferably, the temperatures of eight processing zones of the twin-screw extruder are successively 180° C., 180° C., 185° C., 185° C., 235° C., 235° C., 230° C., and 230° C.

In the present invention, in the front four processing zones of the extruder, HIPS-g-PP graft copolymer is generated in situ through a Friedel Crafts alkylation reaction under a molten state. The graft copolymer can effectively compatibilize the waste HIPS component and the PP component in the blend. In the rear four processing zones of the extruder, by introducing the HIPS-based macromolecular chain extender, in-situ chain-extension occurs under extrusion conditions between the HIPS-based macromolecular chain extender and active groups including hydroxyl generated on HIPS aging chain, so as to achieve chain extension of the waste HIPS. At the same time, through the similar compatibility in approximately similar structures of a main chain in the HIPS-based macromolecular chain extender and a main chain of the waste HIPS, further improvement is made in the weakening of micro-phase interfacial force caused by the aging of waste HIPS.

In the present invention, the processing temperatures of the rear four zones are proactively increased compared with that of the front four zones, thereby achieving two main purposes. On one hand, the alkylation reaction catalyst can be rapidly volatilized and removed through the jump increase of the processing temperature in the fifth zone, to avoid other side reactions that may occur after the introduction of the HIPS-based macromolecular chain extender in the rear section. On the other hand, higher temperature is also conducive to the effective occurrence of chain reaction within a limited retention time. Through a large number of experiments, it has been proven that controlling the screw speed of 40-80 rpm and maintaining the range of processing temperature of the rare four zones at around 230° C. can effectively ensure the in-situ chain expansion effect. Therefore, by changing the processing zone of the front and rear sections, both the occurrence of alkylation reaction and the generation of compatibilizers are ensured, and the effectiveness of waste HIPS chain extension modification is not affected, ultimately resulting in good comprehensive properties of the prepared regenerated alloy.

The present invention has the following advantages.

(1) The present invention directly in-situ modifies waste HIPS and PP to prepare regenerated alloys by using two types of chemical modifiers in combination in segments. The graft copolymer generated by the first alkylation reaction has a significant in-situ compatibilization effect on the two matrices of waste HIPS and PP, improving the interfacial interaction between the two phases and improving the micro-order of the entire blend. The in-situ chain extension repair by the macromolecular chain extender of the same matrix of the second step fundamentally improves the waste HIPS matrix, comprehensively improving its basic properties, and further improving the comprehensive properties of the regenerated alloy.

(2) The processing equipment used in the present invention does not need to be specially modified. Reactive extrusion can be performed and in-situ compatibilization and chain extension modification can be realized only through the optimization of process conditions and formulas, thereby achieving strong adaptability in application and promotion.

(3) With the comprehensive ban on the import of waste plastics in China, there is great potential for the application of recycling technologies for domestic waste plastics, especially high-value recycling technologies. So the present invention provides a brand new solution for the high-value utilization of waste plastics, which is conducive to promoting green recycling of waste plastics, helping to achieve carbon neutrality goals, and achieving good social and economic benefits.

### DESCRIPTION OF THE EMBODIMENTS

The following raw materials are all commercially available products unless otherwise specified.

### Embodiment 1

The regenerated polymer alloy material provided in this embodiment is mainly prepared from the following raw materials in parts by mass:
a waste HIPS: 55,
a PP: 45,
an alkylation reaction catalyst: 0.4,
a co-catalyst: 0.3, and
a HIPS-based macromolecular chain extender: 6.

The waste HIPS is a flake material obtained by crushing and homogenizing waste HIPS (waste high impact polystyrene), and the PP is a new PP (polypropylene) material. The co-catalyst is styrene. The alkylation reaction catalyst is anhydrous aluminum chloride. The HIPS-based macromolecular chain extender is a high impact polystyrene grafted glycidyl methacrylate (HIPS-g-GMA).

The method for preparing the regenerated polymer alloy material comprises the steps of: mixing the waste HIPS, the PP, the alkylation reaction catalyst and the co-catalyst according to the above-mentioned proportion of the raw materials to obtain a mixture material, adding the mixture material from a main feeding device of a twin-screw extruder to melt, controlling a screw rotation speed to 40 rpm, adding the HIPS-based macromolecular chain extender from the fifth processing zone of the twin-screw extruder according to the above-mentioned proportion of the raw materials to blend with a melted mixture material, and then extruding, drawing, cooling and pelletizing to obtain the regenerated polymer alloy material.

The temperatures of eight processing zones of the twin-screw extruder successively are 180° C., 180° C., 185° C., 185° C., 235° C., 235° C., 230° C., and 230° C.

### Embodiment 2

The regenerated polymer alloy material provided in this embodiment is mainly prepared from the following raw materials in parts by mass:
a waste HIPS: 70,
a PP: 30,
an alkylation reaction catalyst: 0.2;
a co-catalyst: 0.1; and
a HIPS-based macromolecular chain extender: 8.

The above components are the same as those in Embodiment 1.

The method for preparing the regenerated polymer alloy material comprises the steps of: mixing the waste HIPS, the PP, the alkylation reaction catalyst and the co-catalyst according to the above-mentioned proportion of the raw materials to obtain a mixture material, adding the mixture material from a main feeding device of a twin-screw extruder to melt, controlling a screw rotation speed to 60 rpm, adding the HIPS-based macromolecular chain extender from the fifth processing zone of the twin-screw extruder according to the above-mentioned proportion of the raw materials to blend with a melted mixture material, and then extruding, drawing, cooling and pelletizing to obtain the regenerated polymer alloy material.

The temperatures of eight processing zones of the twin-screw extruder successively are 175° C., 180° C., 185° C., 185° C., 225° C., 225° C., 225° C., and 230° C.

### Embodiment 3

The regenerated polymer alloy material provided in this embodiment is mainly prepared from the following raw materials in parts by mass:
a waste HIPS: 60,
a PP: 40,
an alkylation reaction catalyst: 0.3,
a co-catalyst: 0.2, and
a HIPS-based macromolecular chain extender: 6.

The above components are the same as those in Embodiment 1.

The method for preparing the regenerated polymer alloy material comprises the steps of: mixing the waste HIPS, the PP, the alkylation reaction catalyst and the co-catalyst according to the above-mentioned proportion of the raw materials to obtain a mixture material, adding the mixture material from a main feeding device of a twin-screw extruder to melt, controlling a screw rotation speed to 80 rpm, adding the HIPS-based macromolecular chain extender from the fifth processing zone of the twin-screw extruder according to the above-mentioned proportion of the raw materials to blend with a melted mixture material, and then extruding, drawing, cooling and pelletizing to obtain the regenerated polymer alloy material.

The temperatures of eight processing zones of the twin-screw extruder successively are 175° C., 180° C., 180° C., 180° C., 225° C., 225° C., 225° C., and 235° C.

The mechanical properties of the regenerated polymer alloy materials prepared in Embodiments 1-3 are summarized in Table 1 below.

Table 1: Summary of Mechanical Properties of the Regenerated Polymer Alloy Materials Prepared in Embodiments 1-3.

| | Impact strength | Tensile |
|---|---|---|
| | (KJ/m²) | strength (MPa) |
| | GB/T 1043 | GB/T 1040 |
| waste HIPS/PP\textcircled{1} | 3.2 | 23.2 |
| Embodiment 1 | 9.3 | 35.6 |
| Embodiment 2 | 8.6 | 32.9 |
| Embodiment 3 | 8.7 | 31.9 |
| Comparative example 1\textcircled{2} | 7.5 | 30.4 |
| Comparative example 2\textcircled{3} | 5.1 | 26.1 |
| Comparative example 3\textcircled{4} | 6.1 | 28.9 |
| Comparative example 5\textcircled{5} | 7.1 | 30.1 |

In Table 1:

\textcircled{1} The preparation method and steps are the same as those in embodiment 1. The material ratio is 55 parts of waste HIPS and 45 parts of PP, and no alkylation reaction catalyst, co-catalyst and HIPS-based macromolecular chain extender is contained.

\textcircled{2} The preparation method and steps are the same as those in Embodiment 1. The material ratio is 55 parts of waste HIPS, 45 parts of PP, 6 parts of HIPS-based macromolecular chain extender, and no alkylation reaction catalyst and co-catalyst is contained.

\textcircled{3} The preparation method and steps are the same as those in Embodiment 1. The material ratio is 55 parts of waste HIPS, 45 parts of PP, 0.4 parts of alkylation reaction catalyst, 0.3 part of co-catalyst, and no HIPS-based macromolecular chain extender is contained.

\textcircled{4} The preparation method, steps and the proportion of the raw materials are the same as those in Embodiment 1, but the temperatures of eight processing zones of the twin-screw extruder successively are 180° C., 180° C., 185° C., 185° C., 185° C., 185° C., 185° C., and 185° C.

\textcircled{5} The preparation method, steps and the proportion of the raw materials are the same as those in Embodiment 1, but the temperatures of eight processing zones of the twin-screw extruder successively are 230° C., 235° C., 235° C., 235° C., 235° C., 235° C., 235° C., and 235° C.

It can be seen from the above-mentioned specific experimental data that, compared to the unmodified waste HIPS/PP, the mechanical properties of the regenerated polymer alloy material prepared by the present invention are improved overall, and the modification effect is significant.

The difference between Embodiments 1 and Comparative example 1(\textcircled{2}) lies in whether the blending system is compatibilized by an alkylation reaction to generate macromolecular compatibilizers. It can be seen that after the addition of the alkylation reaction catalyst, the impact and tensile strength of the regenerated material have been improved to a certain extent, proving that the first step of alkylation reaction modification is very meaningful, which is beneficial for improving the compatibility of the blend and thus improving the comprehensive properties of the regenerated material.

The difference between Embodiments 1 and Comparative example 2(\textcircled{3}) is whether to add the HIPS-based macromolecular chain extender. It can be seen that after adding macromolecular chain extenders, the overall properties are significantly improved (especially for the impact strength that is more sensitive to the main chain molecular weight, molecular chain structure, and phase interface interaction). It can also be proven that the in-situ chain extension repair effect of the second step is good, which can be attributed to its molecular chain extension and phase interface repair effect on the waste HIPS phase after in-situ chain extension modification.

The difference between Embodiments 1 and Comparative example 3(\textcircled{4}) and Comparative example 4(\textcircled{5}) is the processing temperature. The results prove that the processing temperatures of fourth zones of the rear section are proactively and rapidly increased compared with that of the fourth zone of the first section, which is more effective for the modification effect. The processing temperatures of the four zones in the front section are about 180° C., which not only ensures the alkylation reaction, but also avoids the premature volatilization of aluminum chloride at high temperature and the potential chain breaking competition reaction. The processing temperatures of the fourth zones of the rear section are about 230° C., which can quickly volatilize aluminum chloride and ensure the effective implementation of the chain extension reaction.

In summary, through the two-step reactive modification of the present invention, namely alkylation reaction modification and in-situ chain extension repair modification, a double-effect modification effect is achieved, thereby significantly improving the comprehensive properties of the regenerated material. It is very conducive to improving the environmental adaptability of recycled products and broadening their application scenarios. Regenerated alloy products with such comprehensive properties have good market prospects.

The above embodiments are preferred examples of the present invention. The PP, the HIPS-based macromolecular chain extender HIPS-g-GMA, the alkylation reaction catalyst AlCl₃, and styrene selected in the embodiments are obtained from commercially available off-the-shelf products.

However, the implementations of the present invention are not limited to the above-mentioned embodiments, and the waste HIPS and other raw materials selected in the above-mentioned embodiments may also be commercially available ready-made products with similar properties. Changes, modifications, substitutions, combinations, and simplifications which do not depart from the spiritual substances and principles of the present invention are all equivalent alternatives and are intended to be included in the scope of protection of the present invention.

1. A regenerated polymer alloy material, mainly prepared from following raw materials in parts by mass:
a waste high impact polystyrene (HIPS): 55-70,
a polypropylene (PP): 30-45,
an alkylation reaction catalyst: 0.1-0.4,
a co-catalyst: 0.1-0.3, and
a HIPS-based macromolecular chain extender: 2-8.

2. The regenerated polymer alloy material according to claim 1, wherein the waste HIPS is a flake material obtained by crushing and homogenizing a waste HIPS material.

3. The regenerated polymer alloy material according to claim 1, wherein the PP is a new PP material.

4. The regenerated polymer alloy material according to claim 1, wherein the alkylation reaction catalyst is anhydrous aluminum chloride.

5. The regenerated polymer alloy material according to claim 1, wherein the co-catalyst is styrene.

6. The regenerated polymer alloy material according to claim 1, wherein the HIPS-based macromolecular chain extender is a high impact polystyrene grafted glycidyl methacrylate (HIPS-g-GMA).

7. A method for preparing the regenerated polymer alloy material according to claim 1, comprising steps of:
mixing the waste HIPS, the PP, the alkylation reaction catalyst and the co-catalyst according to proportion of the raw materials to obtain a mixture material;
adding the mixture material from a main feeding device of a twin-screw extruder to melt the mixture material;
controlling a screw rotation speed of the twin-screw extruder to 40-80 rpm;
adding the HIPS-based macromolecular chain extender from a fifth processing zone of the twin-screw extruder according to the proportion of the raw materials to blend with the melted mixture material to obtain a resulting material; and
extruding, drawing, cooling and pelletizing the resulting material to obtain the waste HIPS based regenerated polymer alloy material.

8. The method for preparing the regenerated polymer alloy material according to claim 7, wherein a range of a processing temperature of the twin screw extruder is 175˜235° C.

9. The method for preparing the regenerated polymer alloy material according to claim 7, wherein temperatures of eight processing zones of the twin-screw extruder are successively 180° C., 180° C., 185° C., 185° C., 235° C., 235° C., 230° C., and 230° C.
